(19) United States
(12) Patent Application Publication
(10) Pub. No.: US 2026/0167115 A1
(43) Pub. Date: Jun. 18, 2026

(54) Accessory Mount and Pocket

(71) Applicant: Illinois Tool Works Inc., Glenview, IL (US)

(72) Inventors: Laurent Huet, Meru (FR); Eric Leverger, Epone (FR); Adriaan Broodryk, Clichy (FR)

(21) Appl. No.: 19/357,461

(22) Filed: Oct. 14, 2025

(30) Foreign Application Priority Data
Oct. 30, 2024 (EP) 24306828.5
Mar. 28, 2025 (EP) 25166974.3
Sep. 24, 2025 (FR) 2510939

(51) Int. Cl. B60R 7/08; B60R 11/00

(52) U.S. Cl. CPC B60R 7/08; B60R 2011/0057; B60R 2011/0059; B60R 2011/0078; B60R 2011/0084; B60R 2011/0085

(57) ABSTRACT

A pocket suitable for holding an accessory mount. The pocket includes at least one pocket tooth located inside the pocket and arranged to engage a toothed wheel of an accessory mount, an accessory mount, an accessory, an accessory mounting system, and a kit of parts.

### RELATED APPLICATIONS

The present application claims the benefit of European Patent Application No. 24306828.5, filed Oct. 30, 2024, European Patent Application No. 25166974.3, filed Mar. 28, 2025, and French Patent Application No. 2510939, filed Sep. 24, 2025, each titled “Accessory Mount and Pocket,” the contents of which are hereby incorporated by reference.

### BACKGROUND

The application relates to a pocket and an accessory mount, as an accessory mounting system, accessory, and kit of parts.

In the prior art, accessory clip systems have been proposed for attaching a variety of accessories to designated hooks or areas within a vehicle. These systems generally rely on a common interface to allow interchangeable mounting of different accessories such as lights, luggage rings, cords, phone holders, or bottles. Known solutions, however, present notable drawbacks. Certain designs rely on simplified mechanical structures that are inexpensive to produce but provide limited functionality and user convenience. Other designs introduce more sophisticated mechanisms offering improved handling, yet they require a greater number of components, including parts that must be separately sourced and assembled, thereby increasing manufacturing complexity and cost. Consequently, existing accessory clip systems fail to achieve an optimal compromise between ease of production, affordability, and enhanced usability of the interface and hook mechanisms. There is therefore a need for an accessory clip system that combines manufacturing simplicity with improved user functionality while maintaining cost efficiency.

### SUMMARY

The present disclosure relates generally to a pocket, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a front view of an accessory mounting system.

FIG. 2 illustrates a rear view of an accessory mounting system.

FIG. 3A illustrates an assembled accessory mounting system in a first position.

FIG. 3B illustrates an assembled accessory mounting system in a second position.

FIG. 4 illustrates an accessory mounting system arranged upon a rail.

FIG. 5A illustrates an accessory mounting system arranged upon a rail.

FIG. 5B illustrates a rail for the accessory mounting system.

FIG. 6A illustrates an accessory mounting system arranged upon a rail.

FIG. 6B illustrates an accessory mounting system arranged upon a rail.

FIG. 6C illustrates an accessory mounting system disengaged from the rail.

FIG. 6D illustrates an accessory mounting system disengaged from the rail.

FIG. 7A illustrates an exploded view of an accessory mounting system.

FIG. 7B illustrates an alternative exploded view of an accessory mounting system.

FIG. 8A, FIG. 8B and FIG. 8C illustrate the “manual push and pull” alternative of the accessory mounting systems.

FIG. 9 illustrate the “push-push” alternative of the accessory mounting systems.

FIG. 10 illustrates an accessory interface for an accessory mounting system.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “coupled,” “coupled to,” and “coupled with” as used herein, each mean a relationship between or among two or more devices, apparatuses, elements, functions, operations, processes, components, systems, subsystems, and/or means, constituting any one or more of: (i) a connection, whether direct or through one or more other devices, apparatuses, files, elements, functions, operations, processes, components, systems, subsystems, or means; and/or (ii) a functional relationship in which the operation of any one or more devices, apparatuses, elements, functions, operations, processes, components, systems, subsystems, or means depends, in whole or in part, on the operation of any one or more others thereof.

Fasteners vary in size and shape. In some cases, fasteners can be the same shape, but will vary in size. While fasteners are most often associated with creating non-permanent joints. They are also employed in numerous other functions that may require a more permanent fixture. Therefore, the following disclosure should not be limited to fasteners used in non-permanent joints, but rather would be applicable to fastener used in any situation to couple two or more objects.

It is therefore a first non-exclusive object of the disclosure to provide a pocket suitable for holding an accessory mount, the pocket comprising at least one pocket tooth located inside the pocket and arranged to engage a toothed wheel of an accessory mount.

The pocket can comprise a housing, having a well, to capture a toothed wheel.

The pocket can comprise magnetic means to interface with complementary magnetic means of an accessory mount.

The at least one pocket tooth can be such that it allows for indexed rotation of the toothed wheel to hold the accessory mount in a plurality of positions relative to the pocket.

The pocket is reversibly attachable and/or slidable along a rail.

The disclosure also relates to an accessory mount comprising a toothed wheel sized to be securely held within the pocket and for the toothed wheel to engage with the at least one pocket tooth.

The accessory mount can further comprise complementary magnetic means to interface with magnetic means of the pocket.

Additionally or alternatively, the accessory mount can further comprise a connector to connect the accessory mount to an accessory, such as a bayonet fixing.

The disclosure also relates to an accessory comprising the accessory mount.

The accessory is for example any of: a luggage ring; a light; a retractable cord.

Additionally or alternatively, the accessory is provided with a pivot point such that the accessory, or element thereof, may be rotated in an axis different to an axis of rotation of the accessory mount.

The disclosure also relates to an accessory mounting system comprising a pocket and an accessory mount.

Additionally or alternatively, the accessory mount is located within the pocket.

In examples, the accessory mounting system further comprises one or more of: a rail, optionally sized to reversibly and/or slidably receive a pocket as described above, an accessory, wherein the accessory is optionally as described above.

The disclosure also relates to a kit of parts comprising at least one pocket as described above and at least one accessory mount as described above, and optionally wherein the kit of parts further comprises one or more of: a rail, optionally sized to reversibly and/or slidably receive a pocket as described above; an accessory, wherein the accessory is optionally as described above.

This application discloses an accessory mounting system suitable for use in a vehicle. The system is intended to be modular to allow various accessories to be added, removed, and placed, within the vehicle on the whim of an end user.

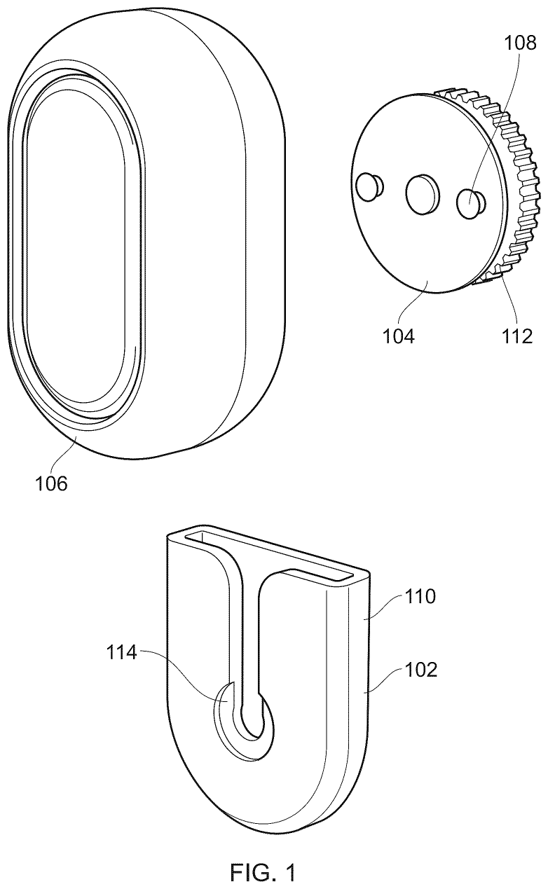

The accessory mounting system shown in FIG. 1 comprises a pocket 102, accessory mount 104, and an accessory 106.

The pocket 102 is suitable for holding the accessory mount 104 securely. The accessory mount 104 is cupped within the accessory mount 104 to provide the required support so a turning moment, produced by the weight of the accessory can be born by the pocket 102 and the surface to which the pocket 102 is mounted.

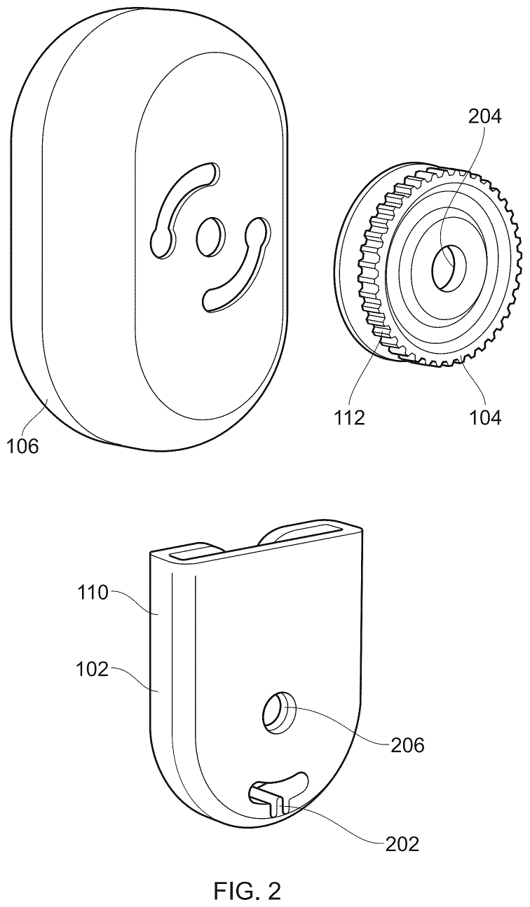

The pocket 102 has at least one pocket tooth 202 (better seen in FIG. 2) located inside the pocket and arranged to engage a toothed wheel 112 of an accessory mount 104. The pocket tooth 202 is preferably resilient allowing the toothed wheel 112 to be intentionally rotated tooth-to-tooth by and end user, but the pocket tooth 202 sufficiently stiff to otherwise prevent the toothed wheel 112 turning within the pocket 102. An indexed rotation of the toothed wheel 112 is therefore achieved allowing an end user to arrange the toothed wheel 112 (and therefore an accessory 106 attached to the 112) in a plurality of positions relative to the 102. The pocket tooth therefore allows for indexed rotation of the toothed wheel to hold the accessory mount in a plurality of positions relative to the pocket.

The pocket comprises a housing in order to provide a void space for the toothed wheel 112 to be pocketed within. The housing has a well, to capture a toothed wheel and allow an axel of the toothed wheel 112 to pass through to which an accessory 106 can be mounted. A disc or washer may be provided upon the axel and spaced apart from the toothed wheel 112 to provide a surface which may be provided with a connector 108 for mounting the accessory 106. The space between the disc advantageously may correspond to a thickness of the wall of the housing adjacent the well, to reduce a wagging movement of the toothed wheel 112 within the pocket 102.

The well may take the form of an elongate notch in the wall of the housing and extending the opening of the pocket 102 for removably receiving the toothed wheel 112.

To ensure the toothed wheel 112 is retained within the pocket 102, both parts may be provided with magnetic means. The pocket 102 comprises magnetic means 206 which are arranged to interface with complementary magnetic means 204 of the accessory mount 104. That is there is an attractive force between the magnetic means of the two parts, thereby preventing unintentional departure of the toothed wheel 112 from the pocket 102.

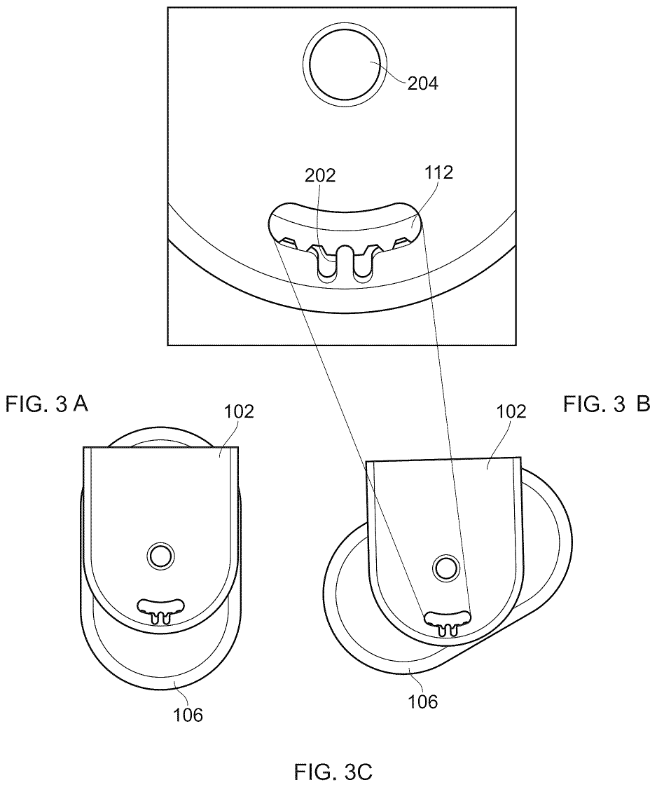

The accessory mount comprises a toothed wheel as described above which is sized to be securely held within the pocket. The toothed wheel is also sized so that once located within the pocket 102, the toothed wheel 112 engages with at least one pocket tooth 202 (see FIG. 3).

As mentioned above, the accessory mount further comprises a connector 108 to connect the accessory mount to an accessory, such as a bayonet fixing which could be formed of a pair of mushroom shaped pegs arranged to located within tapered channels of the accessory 106 to thereby achieve a resistance fit. It will be apparent that any suitable fixation may be used. The accessory 106 may be supplied with or without the accessory mount 104, and the accessory mount 104 may be pre-attached to the accessory 106. Alternatively, the accessory mount 104 may be integrally formed with the accessory 106.

Accessories 106 can include any of: a luggage ring; a light; a retractable cord; and/or any other suitable item a user may which to mount via the accessory mounting system.

The accessory can be provided with a pivot point such that the accessory, or element thereof, may be rotated in an axis different to an axis of rotation of the accessory mount. The accessory 106 may be provided with 2 degrees of freedom of movement to allow a user to position the accessory in a desired position. This could be achieved by providing the accessory 106 with a flip-out part for example.

As best seen in FIG. 2, the accessory mounting system is used in three steps. First a user pushes the connector 108 of the toothed wheel 112 into the corresponding shape at the back of the accessory 106. The user then engages the connector 108, by, for example, turning the toothed wheel 112 clockwise by 90° to lock it on the accessory 106. The User can then push the accessory 106 with the toothed wheel 112 attached into the housing 110 of the pocket 102 until the accessory 106 is locked and the magnetic means are lined up with the complementary magnetic means.

Once in place, the user can rotate the accessory 106 around axis, about the pocket 102 and has the possibility to position the accessory 106 at various angles.

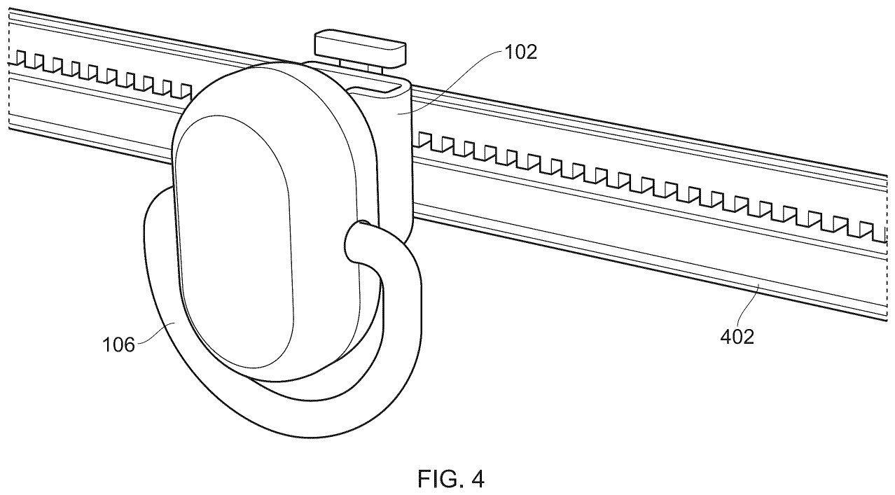

FIG. 4 shows an accessory 106 mounted to a pocket 102 via an accessory mount 104 and then attached to a rail 402. The pocket 102 may be mounted to other attachment points, which may be discrete (i.e. Point locations rather than a rail providing a plurality of mount locations). The pocket 102 may be is reversibly attachable and/or slidable along a rail 402, so that the pocket 102 may be mounted at any desired location along the length of the rail 402 by an end user. The pocket 102 may be provided with a grab mechanism to grab onto and rail 402 and remain in the same location. The grab mechanism could be any suitable, including a spring clip for example. A tab may be provided to allow a user to pull up, and release the grab mechanism to reposition the pocket 102 upon the rail 402. Once moved to the desired position the tab may be then pushed down allowing the grab mechanism to grasp the rail 402 and lock the pocket 102 in the specific location upon the rail 402.

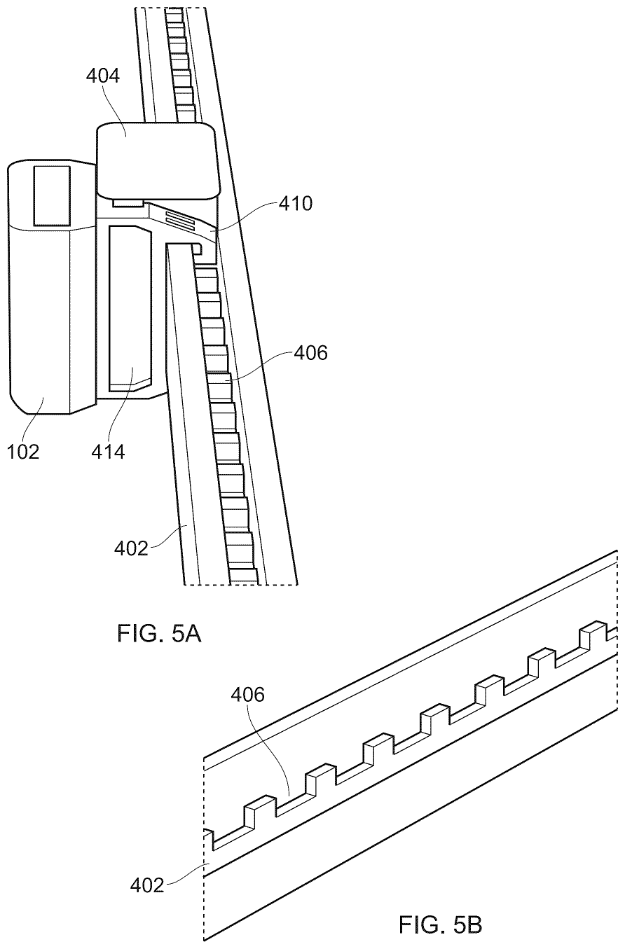

FIG. 5A shows an alternative view of the pocket 102 mounted to a rail 402 via a rail mount 414. The rail mount 414 includes rail guides 410 for attaching to the rail 402. A tab 404 is provided which can be actuated towards or away from notches 406 on the rail 402. The tab 404 actuates a pin which enters the notches 406 in order to hold the pocket 102 in position on the rail 402.

FIG. 5B shows an alternative view of the rail 402 which includes notches 406 which accept the pin to lock the pocket 102 in position.

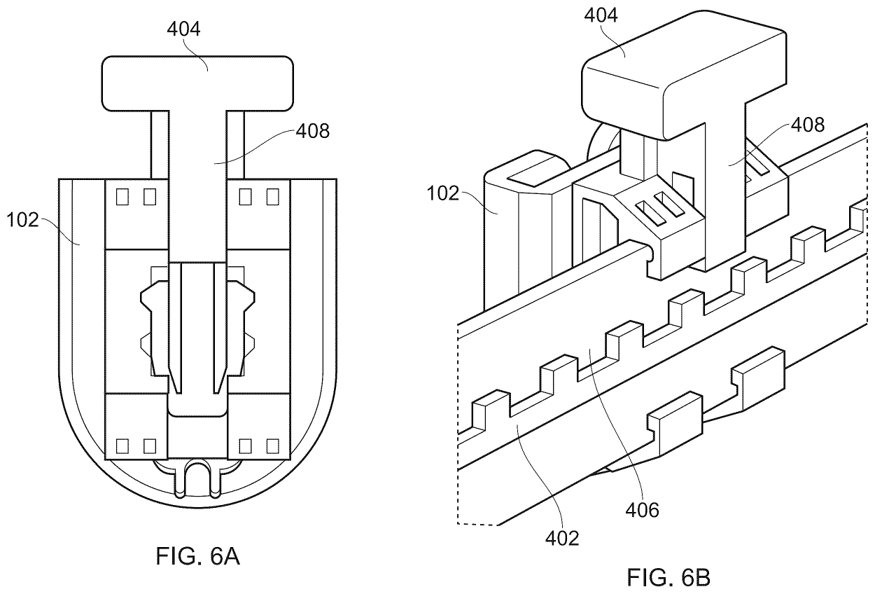

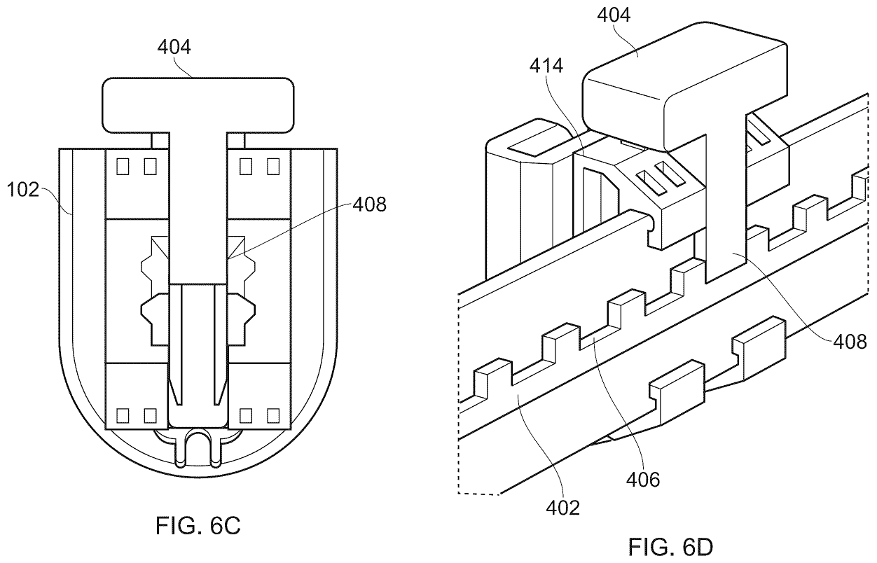

FIG. 6A shows an alternative view of the rail 402 which includes notches 406 which accept the pin 408 to lock the rail mount 414 in position. The tab 404 moves away and toward the rail 402 notches 406. The pin 408 is in the engaged position such that the pocket 102 cannot slide along the rail 402.

FIG. 6B shows the pin 408 in the disengaged position with the pin out of the notches 406 such that the rail mount 414 can slide along the rail 402.

FIG. 6C shows a view of the pocket 102 and the rail mount 414 disengaged from the rail 402. The tab 404 is shown in the engaged position with the pin 408 toward a center of the pocket 102.

FIG. 6D shows a view of the pocket 102 disengaged from the rail 402. The tab 404 is shown in the disengaged position with the pin 408 away from a center of the pocket 102.

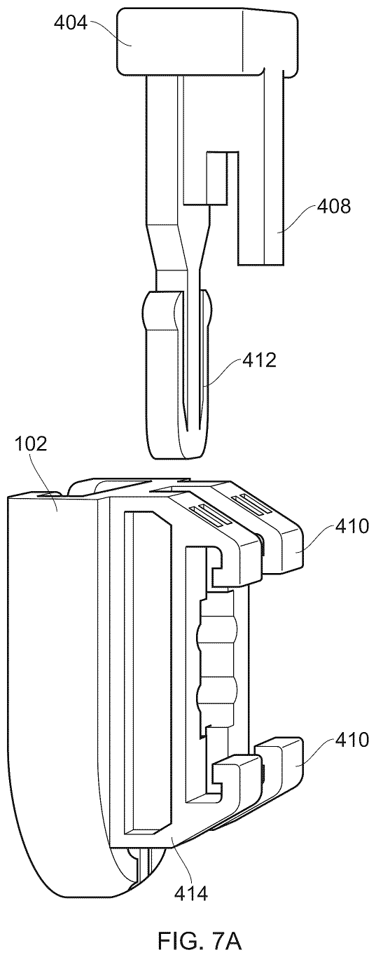

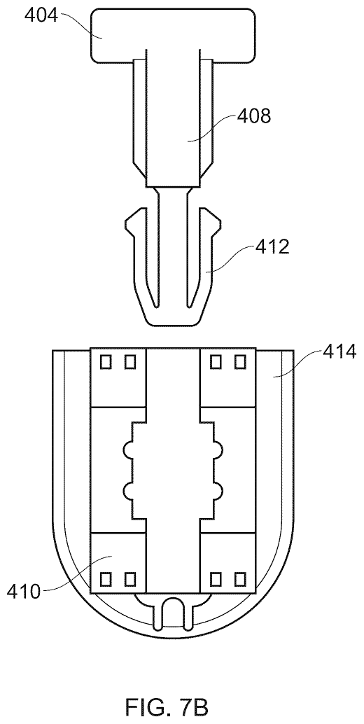

FIG. 7A shows the tab 404 disengaged from the rail mount 414. The pin 408 and a clip 412 are attached to the tab 404. The clip 412 engages with a mechanism within the rail mount 414 such that it can move within the rail mount 414 but cannot be accidentally removed from the rail mount 414. The clip 412 may be an anchor clip or any other known mechanism which can achieve the same effect. The pocket 102 is attached to a rail mount 414 which comprises a rail guide 410 which allows the pocket 102 to slide along the rail 402.

FIG. 7B shows an alternative view of the tab 404 disengaged from the rail mount 414. The pin 408 and a clip 412 are attached to the tab 404.

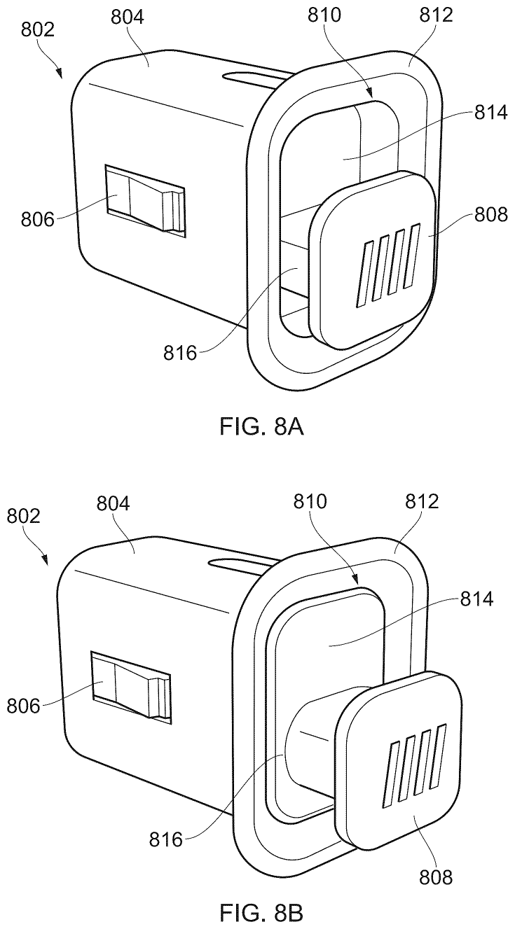

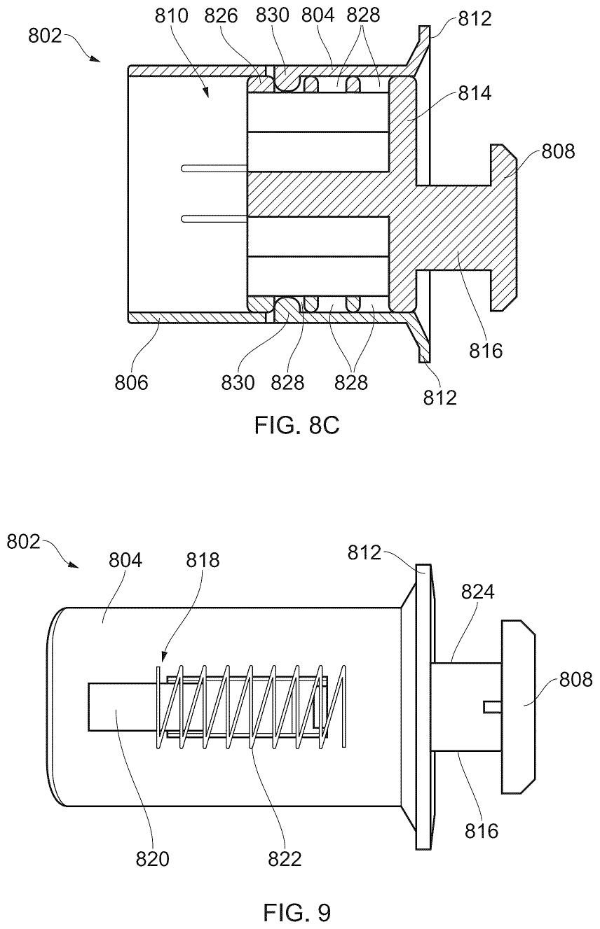

FIG. 8 to FIG. 10 show alternative accessory clip systems having a recessed container and a hook (mushroom headed or any suitable) that may be retained within the recessed container until needed. The hook may be arranged in a deployed position manually or automatically (e.g. By sprung mechanism). Teeth and grips may be provided to provide detents for varying extensions of the hook relative to the recessed container. Accessories may be provided with a common interface to bite on to, and hold, the hook, such as flexible and toothed arms.

FIG. 8A, FIG. 8B and FIG. 8C show a first alternative accessory clip system 802 having a hook 808 and a case 804 having side fixing clips 806 to place the case 804 in a substrate.

The case 804 forms a recessed container 810 wherein the hook 808 is slidably mounted.

The case 804 terminates with a bordure 812 surrounding the recessed container 810, to align said bordure 812 with the substrate where inserted there into.

The accessory clip 802 has several positions of functioning, for example two or three positions, wherein the hook 808 is fixedly more or less deeply inserted into the recessed container 810.

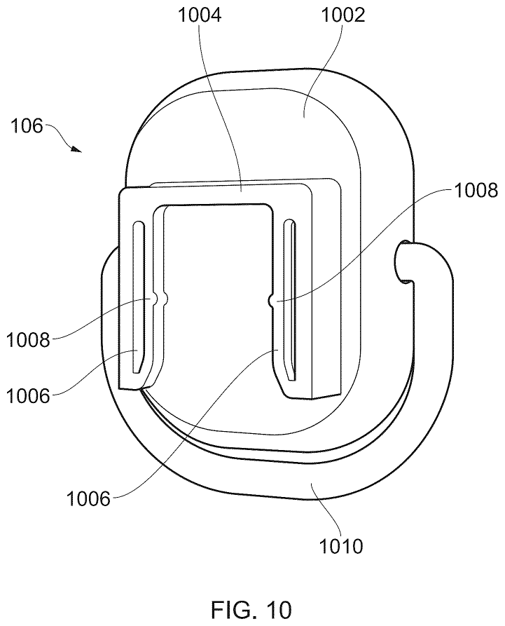

The hook 808 is linked to the case 804 thanks to a body 818 inserted into the casing 804, as shown on FIG. 10.

The hook body 826 joins the hook 808 thanks to a back wall 814 and a feet 816.

As shown on FIG. 8A and FIG. 8B, the first alternative of accessory clip of FIG. 8A, FIG. 8B and FIG. 8C, named the “manual push and pull”, has two positions.

In a first position illustrated by FIG. 8A, the hook 808 and the hook body 826, including the back wall 814 and the feet 816, are fully inserted into the recessed container 810, while in the second position illustrated by FIG. 8B and FIG. 8C, the feet 816 and the hook 808 go out of the recessed container 810.

It allows to have an accessory that can hide a hook 808.

FIG. 8C shows that the hook body 826 has lateral holes 828 that allow positional clips 830 of the case 804 to fix in position the hook body 826 relative to the case 804.

The positional clips 832 form internal integrated clip that bends when the hook 808 is pushed or pulled and clips into one of the corresponding lateral holes 828 to keep the hook 808 in position thanks to the elasticity of the material.

In the illustrated example, three pairs of lateral holes 828 are provided in regard to a pair of positional clips 830 to allow three different positions of the hook 808 regarding the case 804.

In this alternative, the hook 808 is smaller than the recessed container 810. It allows a user to pass a finger or a tool between the bordure 812 and the hook 808 to change the position of the hook 808.

FIG. 9 shows a second alternative of accessory clip, named “push-push”, wherein the hook 808 is sensibly of the same size than the recessed container 810, not allowing a user to pass a finger or a tool between the bordure 812 and the hook 808. Instead, a push mechanism 818 located inside of the case 804 allows to change the position of the hook 808. The push mechanism 902 comprises a latch 820 and a spring 822, configured to work together to close and open the clip assembly 802, such that when the hook 808 is logged in the case 804, it does not protrude out of the case 804 and optionally flushes with the outer surface of the substrate and the bordure 812, and such that a user can push on the hook 808 to open it. Pushing releases the hook 808 from the latch 820 and the spring 822 pushes the hook 808 out of the case 804. To close the hook 808, the user can simply push it back until it is gripped by the latch 820.

FIG. 8A and FIG. 8B illustrate that the side fixing clips 806 allow to fix the clip assembly 802 in a substrate wherein it is inserted. Such side fixing clips 806 exist on both concepts (“manual push and pull” and “push-push”), to make use of clips on the side of the case 804 to clip case 804 inside the trim of a substrate like a wall.

FIG. 10 shows an example of an accessory 106 for the different clip assemblies 802. The hooks 808 of both alternatives have the same accessory mounting system/interface with the accessory 106, comprising, on the hook 808, a flat square button forming a head of the hook 808, and two small indentations 824 (visible on FIG. 9) on the side of the hook feet 816, and additionally, on the accessory 106, a surface 1002 having a U-shaped fixer 1004.

The U-shaped fixer 1004 is configured to surround the hook feet 816. It has two opposite flexible arms 1006 having tooth 1008 configured to cooperate with the indentation 824 of the hook feet 816.

The accessory 106 can slide onto the hook 808 when it is outside the case 804. The accessory will be secured by a clipping sound once it reaches its correct position. To remove, it can be pull up. Then, the hook 808 can be pushed into the case 804.

As illustrated in FIG. 10, the accessory 106 can comprise a ring element 1010 allowing to facilitate the grip thereof, and the pulling out of the accessory 106 regarding the hook 808.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract or drawings), or to any novel one, or any novel combination, of the steps of any method or process so disclosed.

### LIST OF REFERENCE SIGNS

102: pocket
104: accessory mount
106: accessory
108: connector
112: toothed wheel
202: pocket tooth
206: magnetic means
402: rail
404: tab
406: notch
408: pin
410: rail guide
412: clip
414: rail mount
802: accessory clip system
804: case
806: side fixing clips
808: hook
810: recessed container
812: bordure
814: back wall
816: feet
818: body
820: latch
822: spring
824: indentation
826: hook body
828: lateral holes
832: positional clips
902: push mechanism
1004: U-shaped fixer
1010: ring element

What is claimed is:

1. A pocket (102) suitable for holding an accessory mount (104), the pocket (102) comprising at least one pocket tooth (202) located inside the pocket (102) and arranged to engage a toothed wheel (112) of the accessory mount (104).

2. The pocket (102) of claim 1, wherein the pocket (102) comprises a housing (110), having a well (114), to capture the toothed wheel (112).

3. The pocket (102) of claim 1, wherein the pocket (102) comprises magnetic means (206) to interface with complementary magnetic means (204) of an accessory mount (104).

4. The pocket (102) of claim 1, wherein the at least one pocket tooth (202) allows for indexed rotation of the toothed wheel (112) to hold the accessory mount (104) in a plurality of positions relative to the pocket.

5. The pocket (102) of claim 1, wherein the pocket (102) is reversibly attachable and/or slidable along a rail (402).

6. An accessory mount (104) comprising a toothed (112) wheel sized to be securely held within the pocket (102) of claim 1 and for the toothed wheel (112) to engage with the at least one pocket tooth (202).

7. The accessory mount (104) of claim 6, further comprising complementary magnetic means (204) to interface with magnetic means (206) of the pocket (102) of claim 1, and/or
wherein the accessory mount (104) further comprises a connector to connect the accessory mount (104) to an accessory (106), such as a bayonet fixing.

8. An accessory (106) comprising the accessory mount (104) of claim 2,
wherein the accessory (106) is any of: a luggage ring; a light; a retractable cord; and/or
wherein the accessory (106) is provided with a pivot point such that the accessory (106), or element thereof, may be rotated in an axis different to an axis of rotation of the accessory mount (104).

9. An accessory mounting system comprising:
a pocket including at least one pocket tooth located within the pocket and arranged to engage a toothed wheel of an accessory mount; and
the accessory mount including the toothed wheel sized to be securely received within the pocket and to engage the at least one pocket tooth,
wherein the pocket and the accessory mount are configured to hold the accessory mount in a plurality of indexed rotational positions relative to the pocket, and
wherein the accessory mounting system optionally further comprises:
a rail configured to reversibly and/or slidably receive the pocket; and/or
an accessory coupled to the accessory mount, the accessory comprising any of a luggage ring, a light, or a retractable cord, and optionally including a pivot point that permits rotation about an axis different from an axis of rotation of the accessory mount.

10. The accessory mounting system of claim 9, wherein the pocket comprises a housing having a well sized to receive and capture the toothed wheel of the accessory mount.

11. The accessory mounting system of claim 9, wherein the pocket comprises a magnetic element configured to magnetically interface with a complementary magnetic element of the accessory mount.

12. The accessory mounting system of claim 9, wherein the at least one pocket tooth is configured to permit indexed rotation of the toothed wheel to secure the accessory mount in a plurality of angular positions relative to the pocket.

13. The accessory mounting system of claim 9, wherein the pocket is reversibly attachable and/or slidable along a rail.

14. A kit of parts comprising:
at least one pocket including at least one pocket tooth arranged to engage a toothed wheel of an accessory mount; and
at least one accessory mount including the toothed wheel sized to be received within the pocket and to engage the at least one pocket tooth,
wherein the kit further comprises one or more of:
a rail configured to reversibly and/or slidably receive the pocket; and/or
an accessory configured to couple to the accessory mount, the accessory comprising any of a luggage ring, a light, or a retractable cord, and optionally including a pivot point that permits rotation about an axis different from an axis of rotation of the accessory mount.

15. The kit of claim 14, wherein the pocket comprises a housing having a well sized to receive and capture the toothed wheel of the accessory mount.

16. The kit of claim 14, wherein the pocket comprises a magnetic element configured to magnetically engage a complementary magnetic element of the accessory mount.

17. The kit of claim 14, wherein the at least one pocket tooth is configured to permit indexed rotation of the toothed wheel to secure the accessory mount in a plurality of angular positions relative to the pocket.

18. The kit of claim 14, wherein the pocket is reversibly attachable and/or slidable along a rail.
